(19) United States
(12) Patent Application Publication
(10) Pub. No.: US 2026/0046935 A1
(43) Pub. Date: Feb. 12, 2026

(54) ASSOCIATING POLARIZATION TO RANDOM ACCESS CHANNEL TRANSMISSIONS

(71) Applicant: Lenovo (Singapore) Pte. Ltd., Singapore (SG)

(72) Inventors: Sher Ali CHEEMA, Ilmenau (DE); Ali Ramadan ALI, Kraiburg am inn (DE); Majid GHANBARINEJAD, Chicago, IL (US); Vijay NANGIA, WOODRIDGE, IL (US)

(21) Appl. No.: 19/102,306

(22) PCT Filed: Aug. 10, 2023
(86) PCT No.: PCT/IB2023/058101

§ 371 Date: Feb. 7, 2025

Related U.S. Application Data
(60) Provisional application No. 63/396,874, filed on Aug. 10, 2022.

(51) Int. Cl. H04W 74/0833

(52) U.S. Cl. CPC H04W 74/0833

(57) ABSTRACT

Various aspects of the present disclosure relate to methods, apparatuses, and systems that support associating polarization types to random access channel transmissions. For example, a UE and a network entity can share polarization information, such as when the network entity configures the UE to associate a polarization type with RACH resources. The UE can perform RACH occasions (ROs) in the time-frequency domain and/or in the polarization domain during initial access procedures, enhancing coverage and reliability of the random access channel during uplink synchronization, among other benefits.

### CROSS REFERENCE TO RELATED APPLICATIONS

This application is a national phase entry of International Application No. PCT/IB2023/058101 filed Aug. 10, 2023, which claims priority to U.S. Provisional Patent Application No. 63/396,874, filed on Aug. 10, 2022, entitled ASSOCIATING POLARIZATION TO RANDOM ACCESS CHANNEL TRANSMISSIONS, which are hereby incorporated by reference in their entirety.

### TECHNICAL FIELD

The present disclosure relates to wireless communications, and more specifically to network access procedures for user equipment (UEs).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A user communication device performs an initial access procedure, such as a random access channel (RACH) process, to acquire uplink synchronization with a network entity, such as a gNB of a wireless communications system supporting the 5G radio access technology. The RACH process includes the UE sending a RACH preamble (e.g., Msg1) to the gNB, and, after a random access response from the gNB, sending a connection request or scheduled transmission (e.g., Msg3) to the gNB. The gNB, in response to the connection request, sends back a connection setup response indicating a successful uplink connection between the UE and the gNB.

### SUMMARY

The present disclosure relates to methods, apparatuses, and systems that support associating polarization types to random access channel transmissions. A UE and a network entity share polarization information, such as when the network entity configures the UE to associate a polarization type with RACH resources. The UE can perform RACH occasions (ROs) in the time-frequency domain and/or a polarization domain during initial access procedures, enhancing coverage and reliability of the random access channel during uplink synchronization.

Some implementations of the method and apparatuses described herein may further include a UE comprising a processor and a memory coupled with the processor, the processor configured to receive, from a network entity, a configuration indicating a polarization type associated with a physical random access channel (PRACH), and transmit a random access message according to the polarization type associated with the PRACH.

In some implementations of the method and apparatuses described herein, transmitting the random access message includes performing ROs for Msg1 transmission using the polarization type.

In some implementations of the method and apparatuses described herein, the configuration indicates an association of the polarization type to ROs that are multiplexed in a frequency domain in one PRACH duration.

In some implementations of the method and apparatuses described herein, the configuration indicates associations of polarization types with ROs at multiple PRACH duration instances.

In some implementations of the method and apparatuses described herein, the configuration indicates an association of one polarization type with ROs at multiple PRACH duration instances.

In some implementations of the method and apparatuses described herein, the configuration indicates associations of different polarization types with ROs at multiple PRACH duration instances.

In some implementations of the method and apparatuses described herein, the configuration is received from the network entity via radio resource control (RRC) signaling.

In some implementations of the method and apparatuses described herein, the identified polarization type is associated with a PRACH configuration index.

In some implementations of the method and apparatuses described herein, the configuration indicates an association of a polarization type for each symbol within a RO that are frequency multiplexed in one PRACH duration instance.

In some implementations of the method and apparatuses described herein, the network entity is part of a non-terrestrial network (NTN).

In some implementations of the method and apparatuses described herein, the random access message includes a preamble root sequence within which the polarization type is embedded.

In some implementations of the method and apparatuses described herein, the configuration indicates an association of the identified polarization type with frequency resources configured for one RO.

In some implementations of the method and apparatuses described herein, the configuration indicates of ROs that are scheduled on resources in a frequency domain or time domain but associated with different polarization types.

Some implementations of the method and apparatuses described herein may further include a method performed by a UE the method comprising receiving, from a network entity, a configuration indicating a polarization type associated with a PRACH and transmitting a random access message according to the polarization type associated with the PRACH.

In some implementations of the method and apparatuses described herein, the polarization type includes left-hand circular polarization (LHCP) or right-hand circular polarization (RHCP).

In some implementations of the method and apparatuses described herein, the configuration indicates an association of the polarization type to ROs that are multiplexed in a frequency domain within one PRACH duration.

In some implementations of the method and apparatuses described herein, the configuration indicates associations of polarization types with ROs at multiple PRACH duration instances.

In some implementations of the method and apparatuses described herein, the configuration indicates an association of one polarization type with ROs at multiple PRACH duration instances.

In some implementations of the method and apparatuses described herein, the configuration indicates associations of different polarization types with ROs at multiple PRACH duration instances.

In some implementations of the method and apparatuses described herein, the configuration indicates an association of the polarization type with frequency resources configured for one RO.

In some implementations of the method and apparatuses described herein, the configuration indicates an indication of ROs scheduled on resources in a frequency domain or a time domain but associated with polarization types.

Some implementations of the method and apparatuses described herein may further include a network entity comprising a processor and a memory coupled with the processor, the processor configured to cause the network entity to transmit, to a UE, a configuration that associates a polarization type with ROs, wherein the polarization type is associated with ROs in a frequency domain, a time domain, or a combination thereof.

### BRIEF DESCRIPTION OF THE DRAWINGS

FIG. 1 illustrates an example of a wireless communications system that supports associating polarization types to random access channel transmissions, in accordance with aspects of the present disclosure.

FIGS. 2A-2B illustrate examples of diagrams that support time-based association of RACH occasions (ROs) with polarization types in accordance with aspects of the present disclosure.

FIG. 3 illustrates an example of a diagram that supports a mapping of one polarization type to ROs in a time domain in accordance with aspects of the present disclosure.

FIG. 4 illustrates an example of a diagram that supports a mapping of different polarizations type to ROs in a time domain in accordance with aspects of the present disclosure.

FIG. 5 illustrates an example of a diagram that supports a mapping of different polarizations type in one physical random access channel (PRACH) duration in accordance with aspects of the present disclosure.

FIG. 6 illustrates an example of a diagram that supports frequency-based association of ROs with a polarization type in accordance with aspects of the present disclosure.

FIG. 7 illustrates an example of a diagram that supports configuration of ROs in a time-frequency-polarization domain in accordance with aspects of the present disclosure.

FIG. 8 illustrates another example of a diagram that supports configuration of ROs in a time-frequency-polarization domain in accordance with aspects of the present disclosure.

FIG. 9 illustrates an example of a block diagram of a UE that supports associating polarization types to random access channel transmissions in accordance with aspects of the present disclosure.

FIG. 10 illustrates a flowchart of a method that supports associating polarization types to random access channel transmissions in accordance with aspects of the present disclosure.

### DETAILED DESCRIPTION

In wireless communication systems, such as satellite-based networks or other non-terrestrial network (NTNs), performance degradation can occur when polarization is not known or shared between network entities and user communication devices. For example, due to issues with a low link budget for NTNs, polarization mismatches between devices can result in frequent delays in connection establishment processes. Further, polarization mismatches in specific messaging (e.g., Msg1 of the RACH process) can lead to reductions in coverage during initial access procedures, potential beam failures, and other drawbacks.

To address such problems, the technology described herein enables the sharing of polarization between devices, such as the configuration of UEs with polarization type information by network entities. For example, a network entity can configure a UE to associate polarization with RACH resources, such as by explicitly or implicitly indicating to the UE the polarization type to transmit during Msg1 of the RACH process. The configuration can associate polarization types supported by the NTN or other new radio (NR) networks, such as circular polarization types (e.g., left-hand circular polarization, or LHCP, and right-hand circular polarization, or RHCP) to RACH resources. Further, the network entity can configure the UE to perform ROs in the time-frequency domain mid/or a polarization domain.

Thus, the sharing of polarization information during initial access procedures can enhance coverage of the random access channel during uplink synchronization. Further, using circular polarization types, which are orthogonal to one another, provides diversity to messaging (e.g., when applied to the same messages) to enhance coverage and spatial multiplexing (e.g., when applied to different messages) to avoid collisions, resulting in an enhanced overall coverage for Msg1 of the RACH process and enhancement of low coverage channels, among other benefits.

Aspects of the present disclosure are described in the context of a wireless communications system. Aspects of the present disclosure are further illustrated and described with reference to device diagrams and flowcharts.

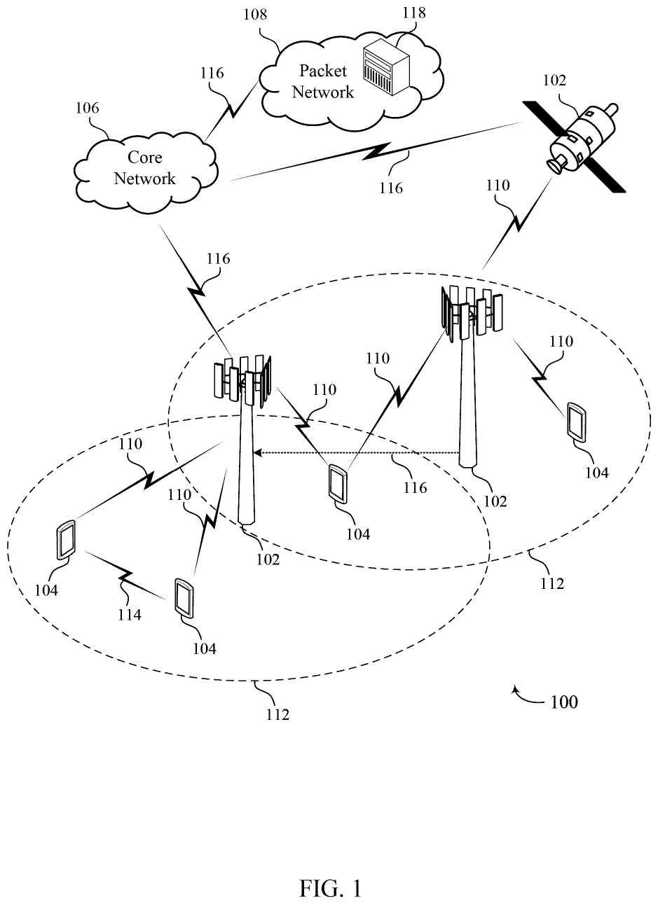

FIG. 1 illustrates an example of a wireless communications system 100 that supports associating polarization types to random access channel transmissions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more Dus or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=³) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz). FR3 (7.125 GHz-24.25 GHz), FR4 (52.6 GHz-114.25 GHz). FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a network entity can configure a UE, via implicit or explicit communication, to associate polarization types to RACH transmissions during access procedures, such as initial access procedures performed by the UE. For example, the configuration can associate ROs with a polarization type (e.g., LHCP, RHCP, or linear), where the association is in a frequency domain, in a time domain (e.g., symbol based within a RO or per RO duration, or slot-based), or a combination thereof.

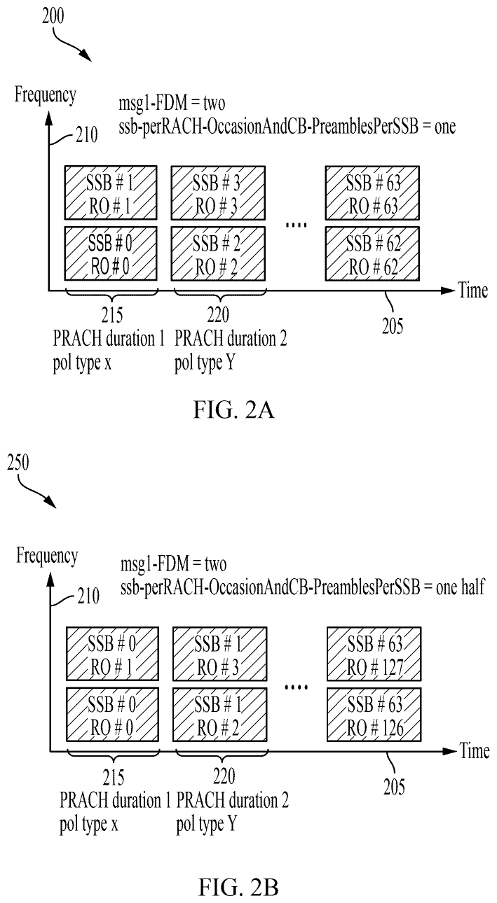

For example, the configuration associates a certain number of PRACH transmission occasions (FDMed) in one RO time instance (PRACH duration N_{dur}^{RA}), where the UE transmits all ROs indicated by “msg1-FDM” at one PRACH duration instance with one type of polarization. FIGS. 2A-2B illustrate examples of diagrams that support time-based association of ROs with polarization types in accordance with aspects of the present disclosure.

As depicted, the configuration can associate same or different polarization types for different PRACH durations

$${N}_{dur}^{RA} ,$$

while the same polarization may be used for all ROs indicated by “msg1-FDM” at one PRACH duration instance. FIGS. 2A-2B illustrate examples of diagrams that support time-based association of RACH occasions (ROs) with polarization types in accordance with aspects of the present disclosure.

Diagram 200 of FIG. 2A illustrates, across a time domain 205 and frequency domain 210, the association of one synchronization signal block (SSB) to one RO. For example, a first polarization type x (e.g., RHCP) is associated with a first PRACH duration 215, and a second, different, polarization type y (e.g., LHCP) is associated with a second PRACH duration 220. Diagram 250 of FIG. 2B illustrates similar associations for one SSB with two ROs.

The network entity can communicate the association of type of polarization with a PRACH duration explicitly or implicitly. For example, the network entity can indicate a new parameter (e.g., “msg1-Pol”) during RACH RRC signaling to indicate the type of polarization associated with different time instances. In some cases, the network entity can add the parameter in IE “RACH-ConfigGeneric,” regardless of whether the random access process is contention free or contention based.

In some cases, the network entity can indicate the parameters by separate RRC IEs for contention free and contention based random access processes. For example, with respect to a contention based random access procedure, the parameters may be common to all UEs in a cell and may be included in IE “RACH-ConfigCommon.” For contention free random access procedures, the parameter may be indicated in IE “RACH-ConfigDedicated.”

The following is an example of a RACH-ConfigGeneric information element modified with the new parameter:

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-Pol | ENUMERATED {LHCP, RHCP,Linear}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED {scf1,scf2,scf4,scf8,scf16,scf32,scf64} |

OPTIONAL, -- Need R

| | |
|---|---|
| prach-ConfigurationFrameOffset-IAB-r16 | INTEGER (0..63) |

OPTIONAL, -- Need R

| | | |
|---|---|---|
| prach-ConfigurationSOffset-IAB-r16 | INTEGER (0..39) | OPTIONAL, |

-- Need R

| | |
|---|---|
| ra-ResponseWindow-v1610 | ENUMERATED { sl60, sl160} |

OPTIONAL, -- Need R

| | | |
|---|---|---|
| prach-ConfigurationIndex-v1610 | INTEGER (256..262) | OPTIONAL |

-- Need R
]]
}
-- TAG-RACH-CONFIGGENERIC-STOP
-- ASN1STOP

In some embodiments, ROs at multiple PRACH duration time instances in a frame can employ the same type of polarization. For example, when a UE receives RACH RRC configuration for TDD FR2, where msg1-Pol is LHCP and prach-ConfigurationIndex is 12, the UE searches for a corresponding RACH transmission symbol, preamble format, and RACH occasion in the time domain by using information in Table 6.3.3.2-4 of TS 38.211. Table 1, depicted below, presents information similar to the information in Table 6.3.3.2-4:

TABLE 1
Information for PRACH configuration index 12 & 74

| | | | | | | | ${N}_{t}^{RA , slot} ,$ | |
|---|---|---|---|---|---|---|---|---|
| | | | | | | | number of | |
| | | | | | | | time- | |
| | | | | | | Number of | domain | |
| PRACH | | | | | | PRACH slots | PRACH occasions | ${N}_{dur}^{RA} ,$ |
| Configuration | Preamble | n_{SFN} mod x = y | | | Starting | within a 60 | within a | PRACH |
| Index | format | x | y | Slot number | symbol | kHz słot | PRACH slot | duration |
| 12 | A1 | 1 | 0 | 19, 39 | 7 | 1 | 3 | 2 |
| 74 | A3 | 1 | 0 | 9, 19, 29, 39 | 7 | 2 | 1 | 6 |

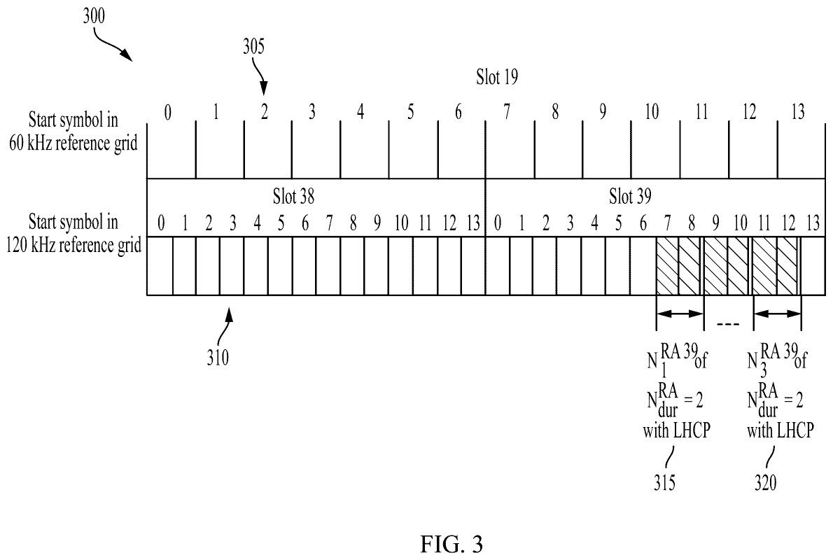

The UE, via the information in Table 1, can calculate or otherwise determine a start symbol for RO in the time domain. For example, based on the information in Table 1, the PRACH duration is two-time domain symbols, there are three ROs within a slot, and all ROs would employ LHCP. FIG. 3 illustrates an example of a diagram 300 that supports a mapping of one polarization type to ROs in a time domain in accordance with aspects of the present disclosure.

The diagram 300 includes a slot in the 60 kHz reference grid 305 (e.g., slot 19), and two slots in the 120 kHz reference grid 310 (e.g., slot 38 and slot 39). Following the information in Table 1, the two ROs 315 and 320 begin at starting symbol 7 with a PRACH duration of 2.

In some embodiments, such as to enhance flexibility and coverage during access procedures, a configuration can indicate different ROs at different PRACH duration time instances being associated with different types of polarization. For example, when the wireless communications system is an NTN, the cell size is very large, and many users may be performing RACH procedures at the same time. Thus, employing different polarizations at different time instances could decrease the probability of preamble collisions by the different users.

The network entity can explicitly indicate the mapping of RO time instances with a polarization type carried out using RRC signaling. For example, the network entity can employ a separate field in RRC signaling to indicate whether a polarization is to be applied for all time instances, or whether different polarizations are to be employed for different time instances. UEs may assume that the indicated polarization is valid for all time instances in a frame when the RRC signaling does not include such information.

In some embodiments, alternate RO duration time instances may employ different types of polarization, where the configuration received by the UE may only indicate the polarization for the first time instance.

In some embodiments, a group of RO durations in consecutive time instances may employ the same type of polarization. The network entity can indicate such an association to the UEs using a value in the RRC signaling that identifies how many consecutive time instances are to use the same type of polarization (e.g., a parameter “Pol duration” that configures the polarization duration). For example, a “Pol duration” of value 0 (or another reserved value) indicates that the same polarization is used for all RO durations, while a “Pol duration” of value 1 indicates that alternate polarization types are to be employed for consecutive RO durations, and so on.

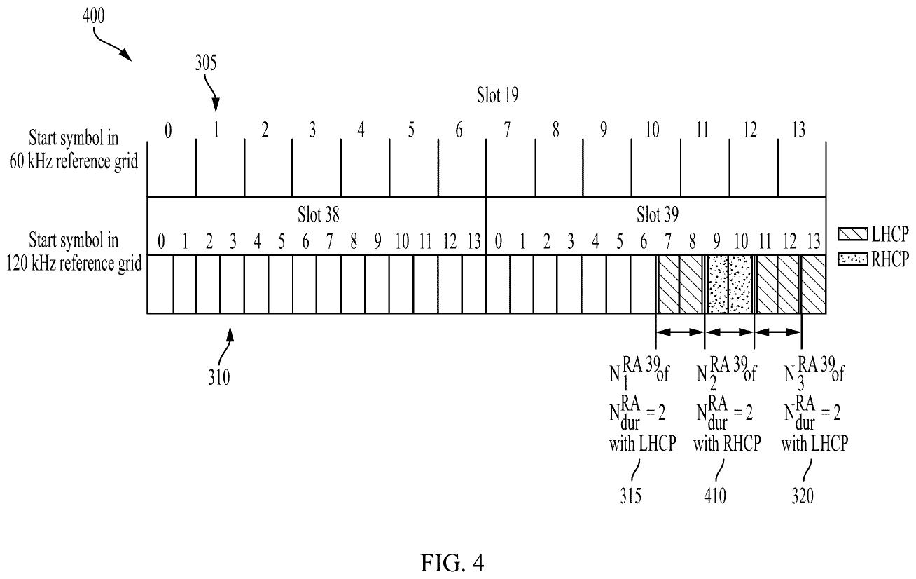

FIG. 4 illustrates an example of a diagram 400 that supports a mapping of different polarizations type to ROs in a time domain in accordance with aspects of the present disclosure. As depicted, when the UE receives prach-ConfigurationIndex of 12 with msg1-Pol of LHCP and Pol duration of one, ROs

$${N}_{1}^{RA 39} 315 and {N}_{3}^{RA 39}$$

320 employ LHCP, while RO

$${N}_{2}^{RA 39}$$

410 employs RHCP.

In some embodiments, a polarization duration and/or polarization type is fixed for a PRACH configuration index, fixed into the specification via a mapping table. Table 2 depicts such a mapping table:

TABLE 2
Polarization mapped to PRACH configuration index

| | | | | | | | ${N}_{t}^{RA , slot} ,$ | | | |
|---|---|---|---|---|---|---|---|---|---|---|
| | | | | | | | number of | | | |
| | | | | | | | time- | | | Polari- |
| | | | | | | Number of | domain | | | zation |
| PRACH Configu- | | | | | | PRACH slots | PRACH occasions | ${N}_{dur}^{RA} ,$ | Polari- | duration per one |
| ration | Preamble | n_{SFN} mod x = y | | Slot | Starting | within a 60 | within a | PRACH | zation | RACH |
| Index | format | x | y | nunber | symbol | kHz slot | PRACH slot | duration | Type | duration |
| 12 | A1 | 1 | 0 | 19, 39 | 7 | 1 | 3 | 2 | LHCP | 0 |
| 74 | A3 | 1 | 0 | 9, 19, 29, 39 | 7 | 2 | 1 | 6 | RHCP | 1 |

As illustrated in Table 2, the PRACH configuration index 12 employs LHCP for all PRACH durations while PRACH configuration index 74 employs an alternate polarization type for every PRACH duration instance (where the first polarization for the RO in slot 9 is RHCP).

In some embodiments, the configuration indicates an association of polarization type to each of the symbols within a RO duration in the time domain, while the same polarization type, or a different polarization type, are associated with the symbols in one PRACH duration. The network entity can configure the association of polarization types with symbols in one PRACH duration via RRC parameters or via a mapping table. For example, the indication can be a default pattern, where alternate symbols use different polarization types. As another example, a configured parameter can indicate a grouping of symbols using the same polarization type.

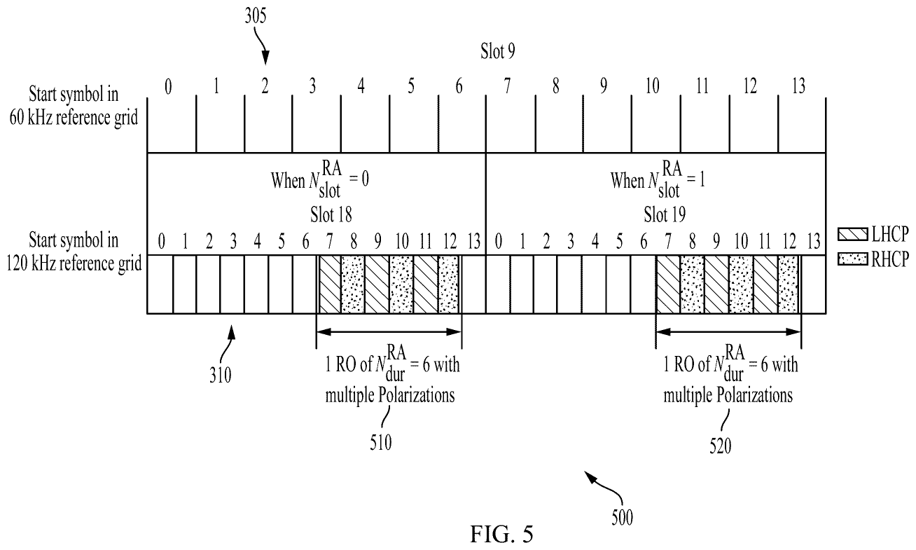

FIG. 5 illustrates an example of a diagram 500 that supports a mapping of different polarizations type in one PRACH duration in accordance with aspects of the present disclosure. The diagram 500, based parameters for PRACH configuration index 74 defined in Table 1, depicts the use of different polarization types for each RO 510, 520. As shown, one PRACH duration includes 6 OFDM symbols, where alternate or different polarization types (e.g., alternating between LHCP and RHCP) are used for consecutive OFDM symbols in one PRACH duration.

In some embodiments, the association of polarization with ROs is mapped through slot number and/or subframe numbers. Thus, the configuration can associate polarization, or a polarization type, with one slot number/subframe number (e.g., all PRACH symbols in that slot or subframe number use one type of polarization).

In some embodiments, the configuration does not explicitly indicate the association of polarization with PRACH duration instances. Instead, a LE can utilize the same polarization as indicated and/or detected for an SSB mapped to the ROs. For example, referring back to FIG. 2B, when SSB 1 uses RHCP and there is no explicit indication for polarization in a performed RACH process, the UE also uses RHCP for PRACH duration time instant 2.

In some embodiments, the UE can embed information about a polarization association with ROs in a preamble root sequence and/or preamble type/length. For example, a certain type of preamble format can always indicate or be associated with a certain polarization (e.g., preamble format A1 uses LHCP, and preamble format A3 uses RHCP). Thus, in some cases, the preamble format can indicate the polarization type to be employed by the ROs.

In some embodiments, a configuration can associate a polarization type to frequency resources, such as frequency resources configured for one RO. The UE can receive the configuration via RRC, as describe herein. The configuration can associate a polarization type to one of the frequency RACH occasions that are configured with “msg1-FDA.”

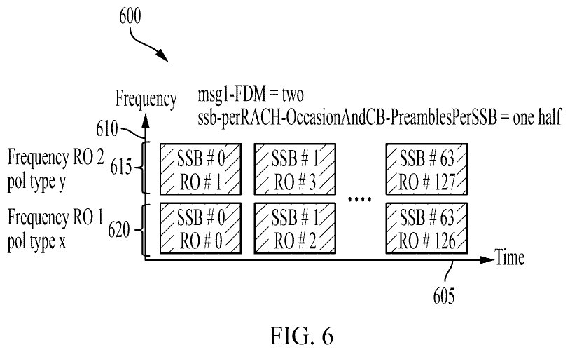

FIG. 6 illustrates an example of a diagram 600 that supports frequency-based association of ROs with a polarization type in accordance with aspects of the present disclosure. The diagram 600, depicting the time domain 605 and frequency domain 610, illustrates that a first RO 615 employs a first type of polarization (e.g., “pol type x”), and a second RO 620 employs a second type of polarization (e.g., “pol type y”).

In some embodiments, the network entity explicitly configures a UE with the polarization type via a RRC parameter that indicates the ROs in the frequency domain and their associated polarization types.

In some embodiments, other RRC parameters (e.g., msg1-FDM and ssb-perRACH-OccasionAndCB-PreamblesPerSSB) can indicate the polarization types. Thus, when one SSB is FDMed to multiple ROs in the frequency domain, the polarization association to the multiple FDMed ROs is defined and utilized by the ROs. For example, if the number of SSBs is 4, msg1-FDM=4 and ssb-perRACH-OccasionAndCB-PreamblesPerSSB is one half, two SSBs are configured with 4 frequency ROs, where one SSB uses two frequency ROs. Based on defined associations of polarization with frequency ROs, the frequency ROs employ the same or different polarizations for one SSB. Following diagram 600, the RO #0 for SSB #0 employs LHCP (as indicated by RRC) and RO #1 for SSB #0 employs RHCP.

In some embodiments, a mapping table can illustrate associations of frequency ROs to polarization types. Similar to Table 2, the mapping table can define an association of frequency ROs with a polarization type for a PRACH configuration index.

In some embodiments, ROs can be defined in the polarization domain, in addition to or separate from the time domain and/or frequency domain. An RO, therefore, can utilize polarization as an additional orthogonal dimension. For example, during access procedures, multiple ROs use the same time-frequency resources but differ in the polarization domain. As described herein, a configuration can map SSB indexes to valid PRACH occasions in time and frequency resources. Similarly, configurations can map ROs in the circular polarization domain.

In some embodiments, the configuration can utilize various orders of mapping, such as (1) in increasing order of preamble indexes within a single PRACH occasion, (2) in increasing order of frequency resource indexes for frequency multiplexed PRACH occasions using a first polarization type, (3) in increasing order of a second polarization type by employing the same time-frequency resources of in the previous type (e.g., when there are more polarization types), (4) in increasing order of time resource indexes for time multiplexed PRACH occasions within a PRACH slot, and/or (5) in increasing order of indexes for PRACH slots.

The network entity can utilize parameters to indicate that ROs are also polarization multiplexed (e.g., “msg1-PDM”) as shown in the following information element RACH-ConfigGeneric IE:

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-Pol | ENUMERATED {LHCP, RHCP, Linear}, |
| msg1-PDM | ENUMERATED {one, two, four, eight}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED {scf1,scf2,scf4,scf8,scf16,scf32,scf64} |

OPTIONAL, -- Need R

| | |
|---|---|
| prach-ConfigurationFrameOffset-IAB-r16 | INTEGER (0..63) |

OPTIONAL, -- Need R

| | | |
|---|---|---|
| prach-ConfigurationSOffset-IAB-r16 | INTEGER (0..39) | OPTIONAL, |

-- Need R

| | |
|---|---|
| ra-ResponseWindow-v1610 | ENUMERATED { sl60, sl160} |

OPTIONAL, -- Need R

| | | |
|---|---|---|
| prach-ConfigurationIndex-v1610 | INTEGER (256..262) | OPTIONAL |

-- Need R
]]
}
-- TAG-RACH-CONFIGGENERIC-STOP
-- ASN1STOP

Depending upon the number of specified polarization types, different values may be specified in the parameter field. For example, “msg1-PDM=1” can indicate there is no polarization multiplexed ROs, while “msg1-PDM=2” can indicate that the PRACH occasions are polarization multiplexed by both LHCP and RHCP in a specified order of mapping.

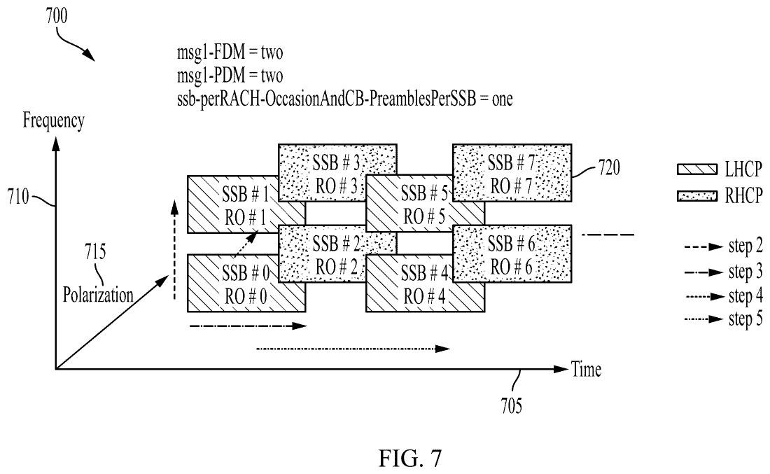

FIG. 7 illustrates an example of a diagram 700 that supports configuration of ROs in a time-frequency-polarization domain in accordance with aspects of the present disclosure. The diagram 700 provides a 3D illustration of a PRACH occasion configuration that maps ROs 720 to all three domains, a time domain 705, a frequency domain 710, and a polarization domain 715.

For example, the field ssb-perRACH-OccasionAndCB-PreamblesPerSSB is read in line with the parameter field “msg1-FDM,” where one SSB shares the same time, frequency, and polarization resources.

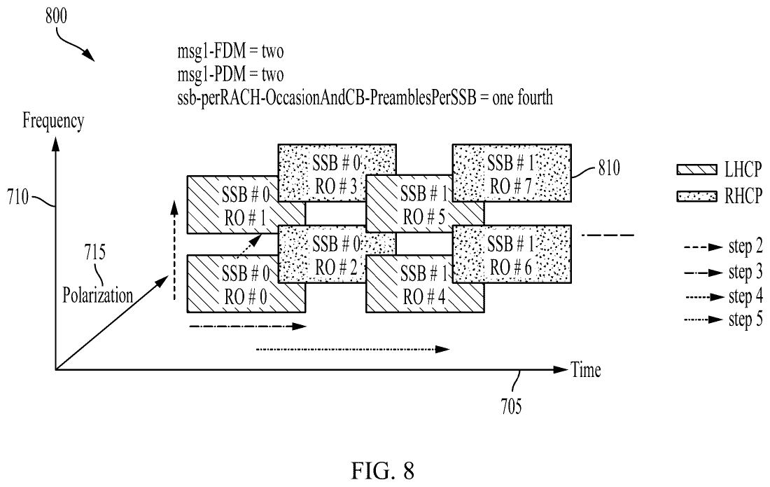

FIG. 8 illustrates another example of a diagram 800 that supports configuration of ROs in a time-frequency-polarization domain in accordance with aspects of the present disclosure. As depicted, when msg1-FDM=2, msg1-PDM=2, and ssb-perRACH-OccasionAndCB-PreamblesPerSSB is one fourth, a single SSB is associated with 4 ROs 810, where the UE utilizes two first frequency resources over a single resource instance of time employing one polarization. The UE then utilizes the next polarization using the same two time and frequency resources (but a different polarization), and then move to the next RO time instance 810, as shown.

Of course, in various embodiments, the UE can follow a different order of mapping than the order depicted in FIG. 7 or 8. For example, the LE can interchange steps 2 and 3 and first increase the preamble indexes within a single PRACH occasion, then increase in the polarization domain, and finally increase in the frequency domain, among numerous different sequences of steps.

Thus, as described herein, a UE, such as the UE 104, can perform random access procedures that employ configured polarization types to enhance coverage during the access procedures and/or prevent or mitigate collisions between other UEs 104, such as within cells of NTNs, among other benefits. As described herein, the UE can configure and associate ROs with SSBs and polarization in the time domain and/or frequency domain. Further, the UE can associate PRACH resources in a polarization domain, and in some cases perform multiple PRACH preamble transmission in the polarization domain to enhance coverage during access procedures, among other benefits.

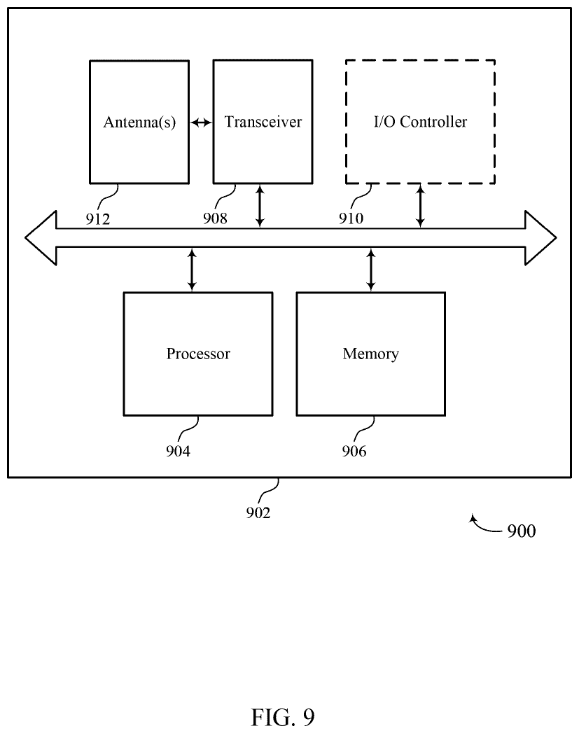

FIG. 9 illustrates an example of a block diagram 900 of a device 902 that supports associating polarization types to random access channel transmissions in accordance with aspects of the present disclosure. The device 902 may be an example of a UE 104 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. Processor 904 may be configured as or otherwise support a means for receiving, from a network entity, a configuration indicating a polarization type associated with a PRACH and transmitting a random access message according to the polarization type associated with the PRACH.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device 902. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

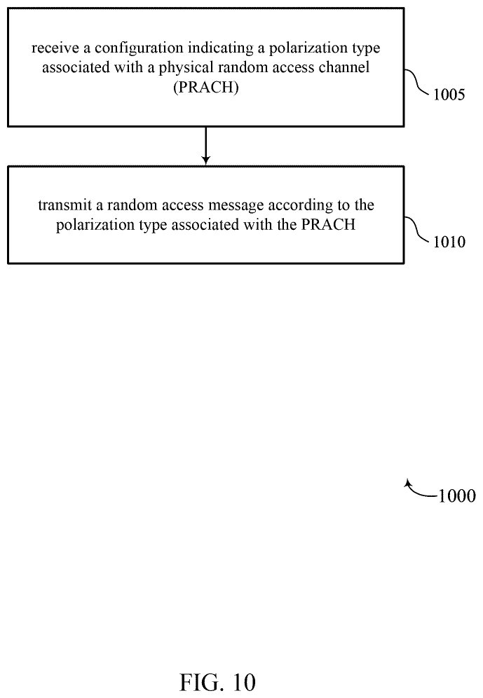

FIG. 10 illustrates a flowchart of a method 1000 that supports associating polarization types to random access channel transmissions in accordance with aspects of the present disclosure. The operations of the method 1000 may be implemented by a device or its components as described herein. For example, the operations of the method 1000 may be performed by the UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1005, the method may include receiving, from a network entity, a configuration indicating a polarization type associated with a PRACH. The operations of 1005 may be performed in accordance with examples as described herein. In some implementations, aspects of the operations of 1010 may be performed by a device as described with reference to FIG. 1.

At 1010, the method may include transmitting a random access message according to the polarization type associated with the PRACH. The operations of 1020 may be performed in accordance with examples as described herein. In some implementations, aspects of the operations of 1010 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims. “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a network entity, a configuration indicating a polarization type associated with a physical random access channel (PRACH); and
transmit a random access message according to the polarization type associated with the PRACH.

2. The UE of claim 1, wherein the at least one processor is configured to cause the UE to transmit the random access message by performing RACH occasions (ROs) for Msg1 transmission using the polarization type.

3. The UE of claim 1, wherein the configuration indicates an association of the polarization type to ROs that are multiplexed in a frequency domain in one PRACH duration.

4. The UE of claim 1, wherein the configuration indicates associations of polarization types with ROs at multiple PRACH duration instances.

5. The UE of claim 1, wherein the configuration indicates an association of one polarization type with ROs at multiple PRACH duration instances.

6. The UE of claim 1, wherein the configuration indicates associations of different polarization types with ROs at multiple PRACH duration instances.

7. The UE of claim 1, wherein the configuration is received via radio resource control (RRC) signaling.

8. The UE of claim 1, wherein the identified polarization type is associated with a PRACH configuration index.

9. The UE of claim 1, wherein the configuration indicates an association of a polarization type for each symbol within a RO that are frequency multiplexed in one PRACH duration instance.

10. The UE of claim 1, wherein the network entity is part of a non-terrestrial network (NTN).

11. The UE of claim 1, wherein the random access message includes a preamble root sequence within which the polarization type is embedded.

12. The UE of claim 1, wherein the configuration indicates an association of the identified polarization type with frequency resources configured for one RO.

13. The UE of claim 1, wherein the configuration indicates of ROs that are scheduled on resources in a frequency domain or time domain but associated with different polarization types.

14. A method performed by a user equipment (UE), the method comprising:
receiving, from a network entity, a configuration indicating a polarization type associated with a physical random access channel (PRACH); and
transmitting a random access message according to the polarization type associated with the PRACH.

15. The method of claim 14, wherein the polarization type includes left-hand circular polarization (LHCP) or right-hand circular polarization (RHCP).

16. The method of claim 14, wherein the configuration indicates an association of the polarization type to RACH occasions (ROs) that are multiplexed in a frequency domain within one PRACH duration.

17. The method of claim 14, wherein the configuration indicates:
associations of polarization types with ROs at multiple PRACH duration instances;
an association of one polarization type with ROs at multiple PRACH duration instances;
associations of different polarization types with ROs at multiple PRACH duration instances;
an association of the polarization type with frequency resources configured for one RO; or
an indication of ROs scheduled on resources in a frequency domain or a time domain but associated with polarization types.

18. A processor for wireless communication, comprising:
at least one controller coupled with at least one memory and configured to cause the processor to:
receive, from a network entity, a configuration indicating a polarization type associated with a physical random access channel (PRACH); and
transmit a random access message according to the polarization type associated with the PRACH.

19. The processor of claim 18, wherein the configuration is received via radio resource control (RRC) signaling.

20. A network entity for wireless communication, comprising:
at least one memory; and
at least one processor coupled with the at least one memory and configured to cause the network entity to:
transmit, to a user equipment (UE), a configuration that associates a polarization type with random access channel (RACH) occasions (ROs),
wherein the polarization type is associated with ROs in a frequency domain, a time domain, or a combination thereof.
